(19) United States
(12) Patent Application Publication
(10) Pub. No.: US 2022/0410056 A1
(43) Pub. Date: Dec. 29, 2022

(54) Filter Securement Assembly

(71) Applicant: 3M INNOVATIVE PROPERTIES COMPANY, St. Paul, MN (US)

(72) Inventors: Tommie W. Kelley, Shoreview, MN (US); Lauren K. Carlson, St. Paul, MN (US); Chad E. Nordling, Stillwater, MN (US); David C. Raithel, Hudson, WI (US); Del R. Lawson, Cottage Grove, MN (US); Christine L. McCool, St. Paul, MN (US); Stephen M. Sanocki, Stillwater, MN (US)

(21) Appl. No.: 17/755,097

(22) PCT Filed: Nov. 13, 2020
(86) PCT No.: PCT/IB2020/060703

§ 371 Date: Apr. 21, 2022

Related U.S. Application Data
(60) Provisional application No. 62/935,728, filed on Nov. 15, 2019.

(51) Int. Cl. B01D 46/18; B01D 46/00; B01D 46/44; B01D 46/68; F24C 15/20

(52) U.S. Cl. CPC B01D 46/185; B01D 46/0093; B01D 46/446; B01D 46/68; F24C 15/2035

(57) ABSTRACT

A method for filtering airborne particulates is described. The method includes providing an exhaust hood, and the exhaust hood defines an intake and the exhaust hood being adapted to receive airborne particulates via the intake. The method also includes conveying a portion of a filter media from a media source area to an active media area, transferring the portion of the filter media from the active media area to a media discard area, the media discard area and the media source area being disposed on substantially opposed sides of the active media area, and severing the portion of the filter media in the media discard area from a remainder of the filter media.

### BACKGROUND

Filters are used for many purposes, such as removing small suspended particulates from air. Filter securement assemblies may retain a filter media proximate an exhaust hood, among other locations.

### SUMMARY

In some aspects, a method for filtering airborne particulates is disclosed. The method can include providing an exhaust hood, the exhaust hood defining an intake and the exhaust hood being adapted to receive airborne particulates via the intake. The method can also include conveying a portion of a filter media from a media source area to an active media area, transferring the portion of the filter media from the active media area to a media discard area, the media discard area and the media source area being disposed on substantially opposed sides of the active media area, and severing the portion of the filter media in the media discard area from a remainder of the filter media.

In some aspects, a filtration system for filtering airborne particulates is disclosed. The filtration system can include an exhaust hood, an intake defined on the exhaust hood, the exhaust hood adapted to receive airborne particulates via the intake, and a filter media disposed proximate the intake, wherein portions of the filter media are disposed in an active area, a media source area, and a media discard area, the media discard area and the media source area being disposed on substantially opposed sides of the active media area.

In some aspects, a filtration system for filtering airborne particulates is disclosed. The filtration system can include an exhaust hood, an intake defined on the exhaust hood, the exhaust hood adapted to receive airborne particulates via the intake, a continuous filter media disposed proximate the intake, portions of the continuous filter media being disposed in an active area located at least partially across the intake, a media source area, and a media receiving area. The media receiving area and the media source area can be disposed on substantially opposed sides of the active media area. A sensor can be in communication with one or more elements of the filtration system, wherein portions of the continuous filter media convey between the media source area and the active media area, and between the active media area and the media receiving area as dictated by signals generated in response to data gathered by the sensor.

In some aspects, a filtration system for filtering airborne particulates is disclosed. The filtration system can include an exhaust hood, an intake defined on the exhaust hood, the exhaust hood adapted to receive airborne particulates via the intake, a source container adjacent the exhaust hood, a receiving container adjacent the exhaust hood and a filter media disposed proximate the intake. Portions of the filter media can be disposed in a media source area proximate the source container. A media receiving area can be proximate the receiving container, and an active area can be disposed at least partially across the intake, the media receiving area and the media source area can be disposed on substantially opposed sides of the active media area. The filtration system can also include a media cleaning apparatus. Portions of the filter media can convey between one or more of the media source area and the media receiving area to the active area via the media cleaning apparatus.

### BRIEF DESCRIPTION OF THE DRAWINGS

FIG. 1 is schematic system view of a filtration system including cooking equipment and an exhaust system, according to exemplary embodiments of the present disclosure.

FIG. 2 is a schematic elevation view of a filter securement assembly, according to exemplary embodiments of the present disclosure.

FIG. 3 is a schematic elevation view of another embodiment of a filter securement assembly, according to exemplary embodiments of the present disclosure.

FIG. 4 is a schematic perspective view of a filter media, according to exemplary embodiments of the present disclosure.

FIG. 5 is a schematic elevation view of another embodiment of a filter securement assembly, according to exemplary embodiments of the present disclosure.

FIG. 6 is a schematic perspective view of another embodiment of a filter securement assembly, according to exemplary embodiments of the present disclosure.

FIG. 7 is a schematic perspective view of another embodiment of a filter securement assembly, according to exemplary embodiments of the present disclosure.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

Filter securement assemblies can be used in a wide range of applications. In some embodiments, filter securement assemblies may be designed for general air filtration to filter primarily airborne particulates. For example, filter media within a filter securement assembly may be designed to filter particles smaller than 10 micrometers in diameter, smaller than 5 micrometers in diameter, smaller than 2.5 micrometers in diameter, smaller than 1.0 micrometer in diameter, smaller than 0.5 micrometers in diameter or smaller than 0.3 micrometers in diameter, among others.

Filter securement assemblies can also be used to secure filter media in a specific location, such as an exhaust hood. Such filter securement assemblies may be used for a specialized purpose, such as for grease filtering in a commercial cooking environment. In commercial kitchens, grease capture in exhaust hoods may be important for health, safety and environmental reasons. However, grease buildup in and around an exhaust hood or an exhaust system may pose a fire hazard. To mitigate the hazard, commercial kitchens typically use airflow interrupters or disrupters, such as baffles, made of a non-flammable material, such as a metal or metal alloy, including stainless steel, galvanized steel or aluminum. The baffle can prevent fire from spreading between the cooking surface and the exhaust system. Additionally, aerosolized grease can travel through the complicated path created by the baffles and condense on the surfaces, resulting in grease accumulating further up in the ducts. However, this grease buildup on the baffle requires regular cleaning to maintain the baffle's effectiveness as a fire barrier and a grease collector. Aesthetically, visible grease on a commercial hood baffle can also be undesirable. Removing, cleaning and reinstalling the baffles can be time consuming, labor-intensive, expensive and dangerous. Thus, versus conventional baffles, the present disclosure can provide a grease-trapping solution that reduces or prevents the buildup of grease on exhaust system components, is light and easy to install near an exhaust hood and can facilitate the easy replacement of filter media proximate the exhaust hood without requiring significant, or any, modifications to the existing exhaust hood or filtration system. Other benefits and uses are also foreseen.

The present disclosure provides a filter securement assembly for receiving and retaining a filter media in an exhaust hood for the filtration of grease droplets. Such a filter securement assembly can also be designed to replace traditional baffles in an exhaust hood by preventing flames from passing through the filter securement assembly and preventing the buildup of grease on portions of the exhaust system downstream of the filter media. For clarity, moving from the cooking equipment through the exhaust system and past the blower can be defined as moving downstream, while moving in the opposite direction can be defined as moving upstream.

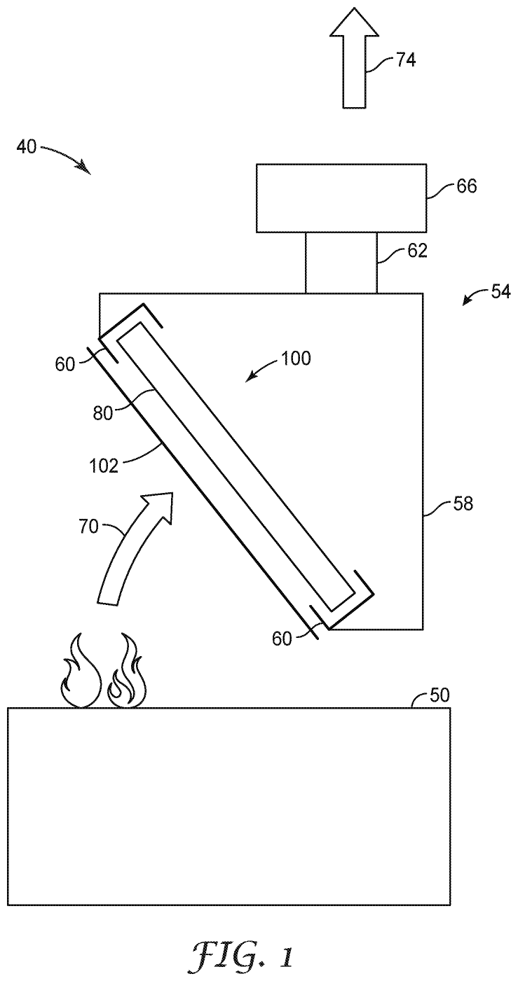

FIG. 1 is a schematic sectional view of a filtration system 40 including cooking equipment 50 and an exhaust system 54. The cooking equipment 50 can be an oven, stove, grill, flyer, broiler or any other commonly used cooking apparatus known to those skilled in the art. The exhaust system 54 can include an exhaust hood 58 defining an intake 59 and an exhaust hood flange 60 and a baffle 80. The exhaust hood 58 can be positioned to capture all or a portion of grease and other particulates generated by the use of the cooking equipment 50. A blower 66 can, via a duct 62, create a reduced-pressure area proximate the cooking equipment 50 (relative to ambient pressure) that can encourage grease and other particulates generated by use of the cooking equipment 50 to enter the exhaust system 54 via the exhaust hood 58 and/or the intake 59. In such a system, as illustrated in FIG. 1, air, gasses, grease and/or particulates can travel into the exhaust system 54 via the exhaust hood 58 and filter media 102, as will be described below), as represented by arrow 70. The filtered air, gasses and any remaining grease and/or particulates can then pass through the duct 62 and blower 66 before exiting the exhaust system 54, as represented by arrow 74. It is to be understood that filter securement assemblies 100 and filter media 102 releasably mounted on, proximate, adjacent and/or in contact with the exhaust hood flange 60 or exhaust hood 58 are within the scope of this disclosure.

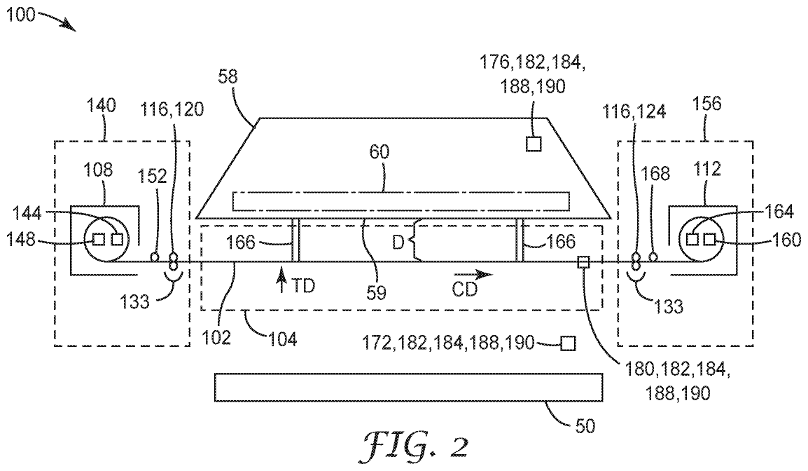

FIG. 2 illustrates an exemplary embodiment of a filter securement assembly 100 and a filter media 102. As can be seen in FIG. 2, the filter securement assembly 100 defines an active area 104, a media source area 140 and a media receiving area 156. The active area 104 can be disposed substantially between the media source area 140 and the media receiving area 156. Further, at least portions of the active area 104 can be disposed between the cooking equipment 50 and the exhaust hood 58. At least portions of the active area 104 can be disposed between the cooking equipment 50 and the exhaust hood 58, such that gasses, air, grease and/or other particulates resulting from cooking on the cooking equipment 50 pass through the active area 104 en route to the exhaust hood 58 and exhaust system 54.

The media source area 140 can be adjacent the active area 104, and further can be adjacent, proximate, on and/or in contact with the exhaust hood 58. A source container 108 can be disposed in the media source area 140. A portion of the filter media 102 can be disposed in and/or secured by the source container 108, and in some embodiments a substantially cylindrical or spiral roll of the filter media 102 can be disposed in and/or secured by the source container 108. The filter media 102 disposed in and/or secured by the source container 108 can be unsaturated, new, virgin or unused filter media 102, meaning filter media 102 that has not been disposed in the active area 104 and/or filter media 102 that is substantially not saturated with gasses, grease, air and/or other particulates resulting from cooking on the cooking equipment 50.

The media receiving area 156 can be adjacent the active area 104, and further can be adjacent, proximate, on and/or in contact with the exhaust hood 58. A receiving container 112 can be disposed in the media receiving area 156. A portion of the filter media 102 can be disposed in and/or secured by the receiving container 112, and in some embodiments a substantially cylindrical or spiral roll of the filter media 102 can be disposed in and/or secured by the source container 108.

As can be seen in FIG. 2, portions of the filter media 102 can be disposed in one or more of the active area 104, media source area 140 and media receiving area 156. Further, portions of the filter media 102 can be conveyed from one of the active area 104, media source area 140 and media receiving area 156 to another of the active area 104, media source area 140 and media receiving area 156. In some embodiments, various technologies in the media receiving area 156 and/or the media source area 140 can convey the filter media 102 from one of the active area 104, media source area 140 and media receiving area 156 to another of the active area 104, media source area 140 and media receiving area 156. In some embodiments, a source motor 144 and/or a source manual conveying apparatus 148 can be disposed in the media source area 140, and further can be adjacent, in contact with, on and/or proximate the source container 108. In some embodiments, a receiving motor 160 and/or a receiving manual conveying apparatus 164 can be disposed in the media receiving area 156, and further can be adjacent, in contact with, on and/or proximate the receiving container 112. The receiving manual conveying apparatus 164 and/or the source manual conveying apparatus 148 can include a crank, drivetrain, chain and sprockets, gears, belts, sliders, ratchets or any other conveying and translation mechanism known to those skilled in the art. The receiving motor 160 and/or the source motor 144 can include linear or rotational electric motors.

The source motor 144, the source manual conveying apparatus 148, the receiving motor 160 and/or receiving manual conveying apparatus 164 can, alone or in combination, convey portions of the filter media 102 from one of the active area 104, media source area 140 and media receiving area 156 to another of the active area 104, media source area 140 and media receiving area 156.

As described, a portion of the filter media 102 can be disposed in the active area 104. In some embodiments, a portion of the filter media 102 in the active area is located at a distance D from the exhaust hood 58, D being measured substantially perpendicularly to a direction of filter media 102 conveyance CD in the active area 104 and/or substantially parallel to a filter media 102 thickness direction TD. In some embodiments, D represents a minimum distance between the portion of the filter media 102 in the active area and the exhaust hood 58. In some embodiments, D represents a maximum distance between the portion of the filter media 102 in the active area and the exhaust hood 58. In some embodiments, D represents an average distance between the portion of the filter media 102 in the active area and the exhaust hood 58. In some embodiments, D represents an approximate distance between the portion of the filter media 102 in the active area and the exhaust hood 58. In various embodiments, D is about, at least or at most 0.0 cm, 0.5 cm, 1.0 cm, 1.5 cm, 2.0 cm, 2.5 cm, 3.0 cm, 3.5 cm, 4.0 cm, 4.5 cm, 5.0 cm, 5.5 cm, 6.0 cm, 6.5 cm, 7.0 cm, 7.5 cm, 8.0 cm, 8.5 cm, 9.0 cm, 9.5 cm, 10.0 cm, 10.5 cm, 11.0 cm, 11.5 cm, 12.0 cm, 12.5 cm, 13.0 cm, 13.5 cm, 14.0 cm, 14.5 cm, 15.0 cm, 15.5 cm, 16.0 cm, 16.5 cm, 17.0 cm, 17.5 cm, 18.0 cm, 18.5 cm, 19.0 cm, 19.5 cm or 20.0 cm. In some embodiments, an operation of the filtration system 40, namely a pressure differential generated by the blower 66, causes a portion of the filter media 102 in the active area 104 to be drawn towards the exhaust hood 58 and/or contact the exhaust hood 58. In some embodiments, one or more hood supports 166 extend from the exhaust hood 58 and/or from another portion of the filtration system 40 and define a minimum value for D by physically maintaining a portion of the filter media 102 in the active area 104 at a minimum distance from the exhaust hood 58.

In some embodiments, one or more media cleaning apparatuses 116 are included in the filter securement assembly 100. The media cleaning apparatus 116 can remove various materials from the filter media 102. In some embodiments, the media cleaning apparatus 116 can remove some or all of gasses, grease and/or other particulates resulting from cooking on the cooking equipment 50 that have been previously absorbed by the filter media 102. Receptacles 133 can collect some or all of the matter removed from the filter media 102 by the media cleaning apparatuses 116. In some embodiments, the media cleaning apparatuses 116 can include a roller apparatus 120 disposed in the media source area 140 and/or an auxiliary roller apparatus 124 disposed in the media receiving area 156, and the filter media 102 can be cleaned when passing between rollers of roller apparatus 120 and auxiliary roller apparatus 124, or between a roller of roller apparatus 120 or auxiliary roller apparatus 124 and another surface. In some embodiments, the media cleaning apparatuses 116 can include compressive elements, such as plates or other surfaces, that clean the filter media 102 by compressing the filter media 102. In some embodiments, the media cleaning apparatuses 116 can include twisting elements that clean the filter media 102 by twisting portions of the filter media 102. In some embodiments, the media cleaning apparatuses 116 can include a fluid cleaning system, whereby a fluid, such as air, water, detergent, degreaser or any other cleaning fluid known to those skilled in the art is used to clean the filter media 102.

In some embodiments, the filter securement assembly 100 can include one or more tensioners that apply a tensile force to a portion of the filter media 102. The filter securement assembly 100 can include a source tensioner 152 disposed in the media source area and/or a receiving tensioner 168 disposed in the media receiving area 156. The source tensioner 152 and/or the receiving tensioner 168 can apply a tensile force to the filter media 102 in the active area 104, media source area 140 and/or media receiving area 156. In some embodiments, a portion of the filter media 102 can be fed into, or inserted into, the source tensioner 152 and conveyed to the receiving tensioner 168, thus not requiring filter media 102 to be stored in the source container 108. Used filter media 102 can also be discarded after being separated from other filter media 102 portions after passing through the receiving tensioner 168.

The filter securement assembly 100 can also include one or more sensors, including an upstream sensor 172 located upstream of the filter media 102, a downstream sensor 176 located downstream of the filter media 102 and/or a filter media sensor 180 located on, proximate, adjacent and/or in direct or indirect contact with the filter media 102.

In some embodiments, one or more of the sensors 172, 176, 180 can include an optical sensor 182. The optical sensor 182 can, via reception of light reflected from a portion of the filter media 102, ascertain various parameters of the portion of the filter media 102. In some embodiments, the optical sensor 182 can ascertain data regarding portions of the filter media 102 disposed within the active area 104. In some embodiments, the optical sensor 182 can ascertain data regarding color, shade, saturation and/or reflectivity of portions of the filter media 102.

In some embodiments, one or more of the sensors 172, 176, 180 can include a timer 184. The timer 184 can record an elapsed time from a start time, and/or can emit a signal at one or more certain times, as will be described below in further detail.

In some embodiments, one or more of the sensors 172, 176, 180 can include a weight (or mass) sensor 188. The weight sensor 188 can, via direct or indirect mechanical connection, ascertain a weight of all or a portion of the filter media 102. In some embodiments, the weight sensor 188 can, via direct or indirect mechanical connection, ascertain a weight of a portion of the filter media 102 disposed in the active area 104.

In some embodiments, one or more of the sensors 172, 176, 180 can include a pressure sensor 190. The pressure sensor 190 can sense an ambient pressure at or proximate the pressure sensor 190. In some embodiments, one of the sensors 172, 176, 180 can include a first pressure sensor and another of the pressure sensors 172, 176, 180 can include a second pressure sensor.

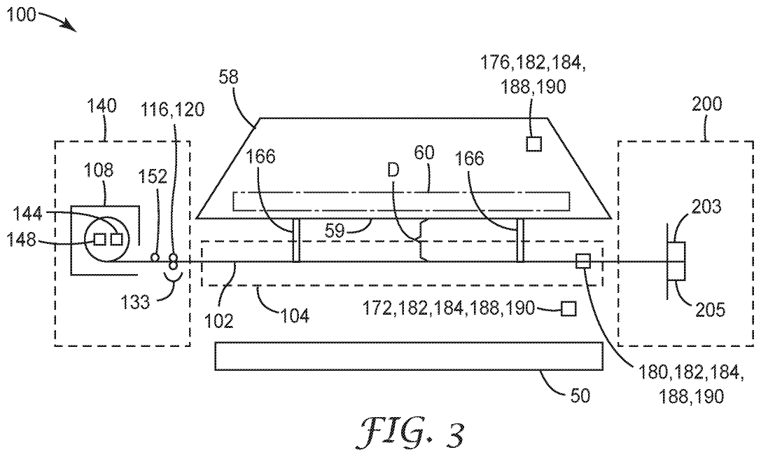

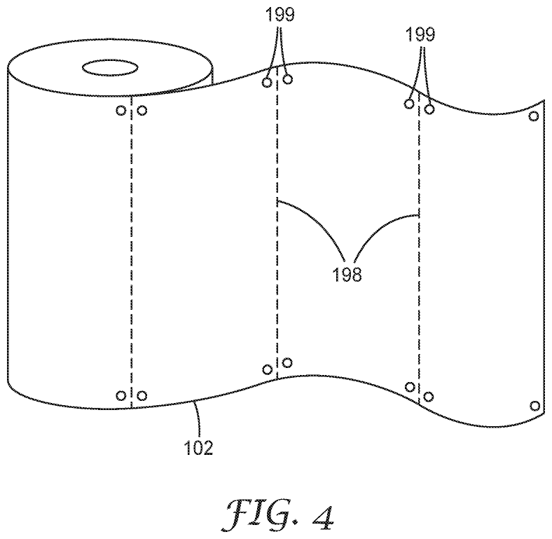

Turning to FIGS. 3 and 4, in some embodiments the filter securement assembly 100 can include a media discard area 200, while the filter media 102 can include a plurality of perforations 198 and/or indicia 199. The perforations 198 can facilitate the separation of a portion of the filter media 102 into two portions (via manual operation or assisted by a tool) at the perforations 198 and the indicia 199 can indicate the location and/or size of the perforations 198 to a user or a sensor 172, 176, 180. Further, a discard motor 203 and/or a discard manual conveying apparatus 205 can be disposed in the media discard area 200.

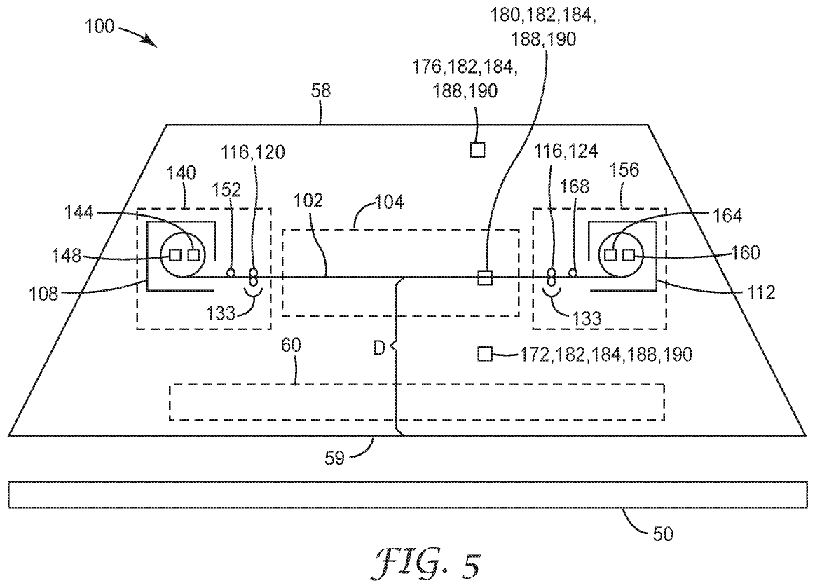

Turning to FIG. 5, elements of the filter securement assembly 100, as described above, can be disposed substantially within the exhaust hood 58.

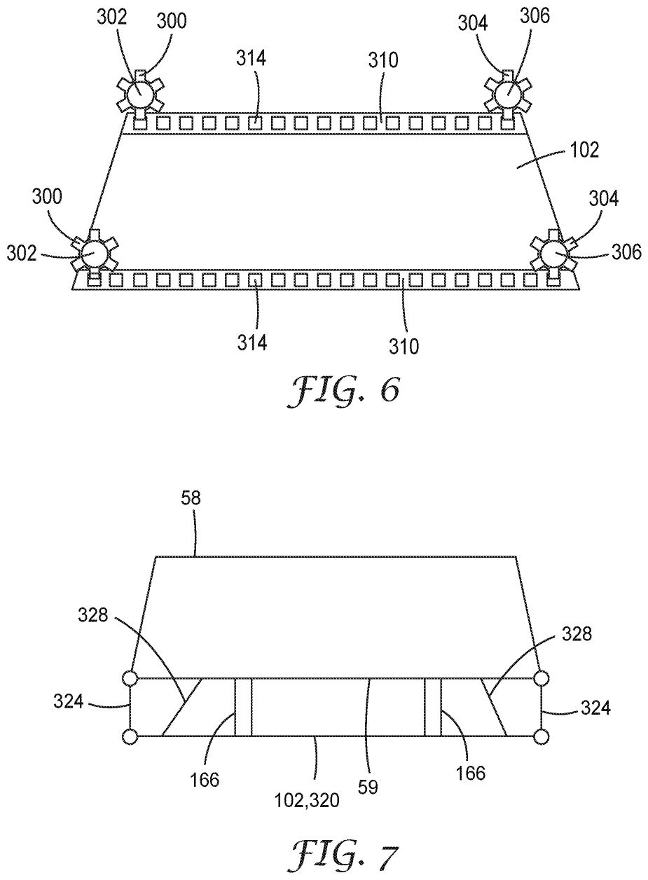

Turning to FIG. 6, the filter securement assembly 100 can include a source sprocket 300, a source sprocket drive 302, a receiving sprocket 304 and/or a receiving sprocket drive 306. Further, the filter media 102 can include one or more areas of reinforcing material 310. Recesses and/or apertures 314 can be disposed in or on the filter media 102, and specifically can be formed in or on the reinforcing material 310. In some embodiments, teeth of the sprockets 300, 302 can engage the recesses and/or apertures 314 to convey portions of the filter media 102 between the media source area 140, active area 104 and media receiving area 156. The reinforcing material 310 can include metal, metal alloys, elastic material, plastics, fire-resistant plastic, polymers, rubbers, tensile materials, braided steel cables, webbed materials or other reinforcing materials know to those skilled in the art.

FIG. 7 illustrates an exemplary embodiment of the filter securement assembly 100 including a filter media section 320 of the filter media 102, one or more attachment mechanisms 324 and one or more tensioning mechanisms 328. The filter media section 320 can be disposed proximate, on, adjacent and/or in contact with the intake 59, and can be connected to the intake via one or more attachment mechanisms 324. The attachment mechanisms 324 can include any conventional permanent or releasable attachment technologies known to those skilled in the art, including, but not limited to, snaps, clamps, magnets, adhesives, mechanical fasteners, hooks, and hook and loop panels. The tensioning mechanisms 328 can apply a tension to the filter media section 320 and can include springs, hydraulics, pneumatics or any other tensioning technology known to those skilled in the art.

In operation, a user or tool can install a portion of the filter media 102 in the media source area 140, and possibly in the source container 108. The user or tool can also dispose a portion of the filter media 102 in the active area 104 and in the media receiving area 156, possibly in the receiving container 112. Operations of the cooking equipment 50 can produce gasses, grease and/or particulates that are drawn into the exhaust system 54 and through the filter media 102 disposed in the active area 104. The gasses, grease and/or other particulates can gradually accumulate in the portion of the filter media 102 disposed in the active area 104. In some embodiments, data readings by a sensor 172, 176, 180 can be taken as the gasses, grease and/or other particulates accumulate in the portion of the filter media 102 disposed in the active area 104.

In some embodiments, a data reading by a sensor 172, 176, 180 taken as the gasses, grease and/or other particulates accumulate in the portion of the filter media 102 disposed in the active area 104 reaches a particular threshold (T1). In some embodiments, a difference between a data reading by a sensor 172, 176, 180 taken as the gasses, grease and/or other particulates accumulate in the portion of the filter media 102 disposed in the active area 104 and a data reading taken by a sensor 172, 176, 180 before gasses, grease and/or other particulates accumulate in the portion of the filter media 102 disposed in the active area 104 reaches a particular threshold (T2).

For example, the optical sensor 182 can detect a particular color, shade, saturation and/or reflectivity as a T1 threshold, and/or the optical sensor 182 can detect a difference in a particular color, shade, saturation and/or reflectivity as a T2 threshold. The weight sensor 188 can detect a particular weight of the filter media 102 and/or of the filter media 102 disposed in the active area 104 and/or the weight sensor 188 can detect a difference in weight of the filter media 102 and/or of the filter media 102 disposed in the active area 104 as a T2 threshold. The timer 184 can note a particular time as a T1 threshold and/or the timer 184 can note a difference in time as a T2 threshold. The pressure sensor 190 can detect a particular pressure as a T1 threshold and/or the pressure sensor 190 can detect a difference in pressure as a T2 threshold. Further, the downstream sensor 176 can include a first pressure sensor and the upstream pressure sensor 190 can include a second pressure sensor and a difference between the pressures sensed at the downstream sensor 176 and the upstream sensor 172 can be a T2 threshold.

By any of the above metrics, when a particular threshold (T1 and/or T2) is reached, the sensors 172, 176, 180 can signal that the filter media 102 disposed in the active area 104 is sufficiently saturated and should thus be conveyed to the media receiving area 156 and possibly the receiving container 112. This can be accomplished via one or more of the source motor 144 and the receiving motor 160. In some embodiments, the signal generated by the sensors 172, 176, 180 can indicate to a user that the filter media 102 disposed in the active area 104 is sufficiently saturated and should thus be conveyed to the media receiving area 156 and possibly the receiving container 112. This can be accomplished by one or more of the source manual conveying apparatus 148 and the receiving manual conveying apparatus 164. The filter media 102 conveyed from the active area 104 is then conveyed to the media receiving area 156 and possibly the receiving container 112.

In some embodiments, one or more of the media cleaning apparatuses 116 can remove all or a portion of the accumulated grease, gasses and/or particulate matter absorbed in the filter media 102 from operations of the cooking equipment 50 as the filter media 102 passes therethrough during conveyance. Thus, filter media 102 can accumulate grease, gasses and/or particulate matter in the active area 104, be wholly or partially cleaned by the media cleaning apparatus 116, be conveyed to one or more of the media source area 140 and the media receiving area 156, and can then be conveyed again to the active area 104 for re-use.

In some embodiments, as illustrated by FIGS. 3 and 4, the operations can be similar to that described above, however when a particular threshold (T1 and/or T2) is reached, the sensors 172, 176, 180 can signal that the filter media 102 disposed in the active area 104 is sufficiently saturated and should thus be conveyed to the media discard area 200. This can be accomplished via one or more of the source motor 144 and the discard motor 203. In some embodiments, the signal generated by the sensors 172, 176, 180 can indicate to a user that the filter media 102 disposed in the active area 104 is sufficiently saturated and should thus be conveyed to the media discard area 200. This can be accomplished by one or more of the source manual conveying apparatus 148 and the discard manual conveying apparatus 205. The filter media 102 conveyed from the active area 104 is then conveyed to the media discard area 200, where a user, tool or other mechanism of the filter securement assembly 100 separates the filter media 102 into two portions at the perforations 198, as dictated by the indicia 199. The separated filter media 102 can then be discarded or cleaned for future use.

The filter media 102 can include any one or more materials or mechanical filter arrangements known to those skilled in the art. In particular, the filter media 102 can include any one or more of a Flame-Resistant (FR) media web, a woven material, a non-woven material, oxidized polyacrylonitrile (OPAN), FR rayon, modacrylic, basalt, fiberglass, wool and ceramic. In some embodiments, the filter media 102 includes a conventional filter media material (such as polyolefin) that has been treated or coated to be flame-resistant. In some embodiments, the filter media 102 includes a conventional filter media material and a metal mesh and/or a flame-resistant barrier. In various embodiments, the filter media 102 can be pleated, non-pleated and/or multilayered, based upon application.

The filter securement assembly 100 and filtration system 40, and each element thereof, can include one or more of a metal (such as aluminum), metal alloy (such as stainless steel), fiberglass, ceramic, composite material, carbon composite material, stone, plastic, wood-based product, a Flame-Resistant (FR) material, a material treated and/or coated with an FR material or any other suitable material known to those skilled in the art.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present disclosure. Thus, it should be understood that although the present disclosure has been specifically disclosed by specific embodiments and optional features, modification and variation of the concepts herein disclosed may be resorted to by those of ordinary skill in the art, and that such modifications and variations are considered to be within the scope of embodiments of the present disclosure. The complete disclosures of the patents, patent documents, and publications cited herein are incorporated by reference in their entirety as if each were individually incorporated. To the extent that there is any conflict or discrepancy between this specification as written and the disclosure in any document that is incorporated by reference herein, this specification as written will control.

What is claimed is:

1. A method for filtering airborne particulates, comprising:
providing an exhaust hood, the exhaust hood defining an intake and the exhaust hood being adapted to receive airborne particulates via the intake;
conveying a portion of a filter media from a media source area to an active media area;
transferring the portion of the filter media from the active media area to a media discard area, the media discard area and the media source area being disposed on substantially opposed sides of the active media area; and
severing the portion of the filter media in the media discard area from a remainder of the filter media.

2. The method of claim 1, wherein a tensioner acting on the filter media increases a tensile force on the portion of the filter media in the active media area.

3. The method of claim 1, wherein the filter media includes a flame-resistant material.

4. A filtration system for filtering airborne particulates, comprising:
an exhaust hood;
an intake defined on the exhaust hood, the exhaust hood adapted to receive airborne particulates via the intake; and
a filter media disposed proximate the intake, wherein portions of the filter media are disposed in an active area, a media source area, and a media discard area, the media discard area and the media source area being disposed on substantially opposed sides of the active media area.

5. The filtration system of claim 4, wherein a tensioner acting on the filter media increases a tensile force on the portion of the filter media in the active media area.

6. The filtration system of claim 4, wherein the filter media includes a flame-resistant material.

7. A filtration system for filtering airborne particulates, comprising:
an exhaust hood;
an intake defined on the exhaust hood, the exhaust hood adapted to receive airborne particulates via the intake;
a continuous filter media disposed proximate the intake, portions of the continuous filter media being disposed in an active area located at least partially across the intake, a media source area, and a media receiving area, the media receiving area and the media source area being disposed on substantially opposed sides of the active media area; and
a sensor in communication with the continuous filter media, wherein portions of the continuous filter media convey between the media source area and the active media area, and between the active media area and the media receiving area as dictated by signals generated in response to data gathered by the sensor.

8. The filtration system of claim 7, wherein the sensor is a pressure sensor.

9. The filtration system of claim 7, wherein the sensor is disposed in the filtration system downstream of the portion of the continuous filter media disposed in the active media area.

10. The filtration system of claim 7, wherein the sensor is an optical sensor in optical communication with the portion of the continuous filter media disposed in the active media area.

11. The filtration system of claim 7, wherein the sensor is a weight sensor in mechanical communication with the portion of the continuous filter media disposed in the active filter area.

12. The filtration system of claim 7, wherein the continuous filter media includes a flame-resistant material.

13. A filtration system for filtering airborne particulates, comprising:
an exhaust hood;
an intake defined on the exhaust hood, the exhaust hood adapted to receive airborne particulates via the intake;
a source container adjacent the exhaust hood;
a receiving container adjacent the exhaust hood;
a filter media disposed proximate the intake, portions of the filter media being disposed in a media source area proximate the source container, a media receiving area proximate the receiving container, and an active area disposed at least partially across the intake, the media receiving area and the media source area being disposed on substantially opposed sides of the active media area; and
a media cleaning apparatus,
wherein portions of the filter media convey between one or more of the media source area and the media receiving area to the active area via the media cleaning apparatus.

14. The filtration system of claim 13, wherein the media cleaning apparatus includes a roller assembly.

15. The filtration system of claim 13, wherein the media cleaning apparatus is disposed substantially between the media receiving area and the active media area, as measured along the filter media.

16. The filtration system of claim 15, further including an auxiliary media cleaning apparatus, wherein the auxiliary media cleaning apparatus is disposed substantially between the active media area and the media source area, as measured along the filter media.

17. The filtration system of claim 13, wherein a tensioner acting on the filter media increases a tensile force on the portion of the filter media in the active media area.

18. The filtration system of claim 13, wherein the filter media includes a flame-resistant material.
